(19) United States
(12) Patent Application Publication
(10) Pub. No.: US 2021/0133622 A1
(43) Pub. Date: May 6, 2021

(54) ML-BASED EVENT HANDLING

(71) Applicant: INTERNATIONAL BUSINESS MACHINES CORPORATION, Armonk, NY (US)

(72) Inventors: Michael Elton Nidd, Zurich (CH); Hagen Völzer, Zurich (CH); Sander Plug, Noordwijk (NL); Larisa Shwartz, Greenwich, CT (US)

(21) Appl. No.: 16/670,748

(22) Filed: Oct. 31, 2019

(51) Int. Cl. G06N 20/00; G06F 16/25; G06N 5/02

(52) U.S. Cl. CPC G06N 20/00; G06N 5/027; G06F 16/258

(57) ABSTRACT

The invention relates to a computer-implemented method for processing events. The method provides a database comprising original event objects stored in association with canonical event objects. The method executes a learning algorithm on the associated original and canonical event objects for generating a trained ML program adapted to transform an original event object of any one of the one or more original data formats into a canonical event object having the canonical data format and uses the trained machine learning program for automatically transforming original event objects generated by an active IT-monitoring system into canonical event objects processable by an event handling system.

### BACKGROUND

The present invention relates to event management systems, and more specifically to the management of events generated by one or more IT-monitoring systems.

IT-related solutions are meanwhile of crucial importance in basically all areas of life. New developments in the areas of Big Data, Cloud Computing and the Internet of Things often require large, powerful and reliably available IT systems. These requirements also increase the complexity of these IT-systems and hence the complexity of monitoring and maintaining these systems. Critical events such as lack of memory, CPU and/or network capacity can quickly lead to the failure of important or all system components, especially in complex, distributed and heterogeneous systems. Often a quick, preferably fully automatic countermeasure is necessary when a critical event occurs to prevent a system failure and further damage such as data loss or the destruction of hardware components. Manual event management is often no longer an option due to the complexity of the systems and the need to react quickly to any critical system event.

A further problem associated with manual system control is that given the complexity of many current IT-systems, it is difficult, if not impossible, to anticipate all possible fault modes, to exactly determine their system-wide effects and to explicitly specify the best mode of action to keep the system up- and running.

A growing number of IT-system components, including both hardware and software components, come with some automated self-monitoring and diagnosis functions. These component-internal functions may indicate the current state of this individual component, e.g. the percentage of a logical or physical storage volume currently used, the current number of unoccupied CPUs in a multi-node CPU cluster etc., and may be used as basis by automated event-handling tools to monitor and control the state of a complex IT system.

However, in practice, the automatic event handling and control of complex IT systems is often a big challenge: complex IT systems are often historically grown and heterogeneous. This means that these systems contain a unique composition of hardware and/or software components from different suppliers. The system architecture is tailored to the needs of the respective owner or the intended use of the system and is therefore unique. Even in case two systems have the same set of components, the requirements in terms of how system events are handled may strongly differ depending on the respective requirements and use case scenarios. Furthermore, there does not exist a common standard for the messages generated by the automated self-monitoring and diagnosis functions of the system components.

There are some automated event handling systems for complex IT-systems on the market. However, due to the heterogeneity of system components and event message formats, there does not exist an event handling tool that is able to interpret all event messages of all software and hardware components of current IT systems. This may force an admin to maintain several event handling systems for different sub-sets of IT-system components. This results in a functional fragmentation of the IT-system management and may greatly reduce the maintainability and availability of the IT-system.

Hence, event management in complex, heterogeneous IT-systems is a difficult, error-prone task with practical limitations that often result in system failures, reduced system flexibility, and maintainability.

### SUMMARY

The invention relates to a computer-implemented method, computer readable storage medium and corresponding computer system for processing events generated by one or more IT-monitoring systems as specified in the independent claims. Embodiments of the invention are given in the dependent claims. Embodiments of the present invention can be combined freely with each other if they are not mutually exclusive.

In one aspect, the invention relates to a computer-implemented method for processing events. The method provides a database comprising a plurality of original event objects respectively being stored in association with a canonical event object, where the original event objects being generated by one or more IT-monitoring systems, where each of the original event object having an original data format being particular for the type of IT monitoring system having generated the original event object, where each original event object comprising one or more data values characterizing an event, the canonical event objects having a shared canonical data format, where each canonical event object comprising a class-ID being indicative of the one out of a plurality of event classes to which its associated original event object has been assigned for handling the event represented by the original event object, the canonical event object comprising one or more attribute values derived from the data values of the associated original event object, executing a learning algorithm on the associated original and canonical event objects for generating a trained machine learning program adapted to transform an original event object of any one of the one or more original data formats into a canonical event object having the canonical data format, The method uses the trained machine learning program for automatically transforming original event objects generated by an active IT-monitoring system into canonical event objects respectively being processable by an event handling system, the active IT-monitoring system being one of the one or more IT-monitoring systems or of a further IT-monitoring system.

In a further aspect, the invention relates to a computer readable storage medium having program instructions embodied therewith, the program instructions executable by a processor to cause the processor to execute a method for processing events. The method provides a database comprising a plurality of original event objects respectively being stored in association with a canonical event object, the original event objects being generated by one or more IT-monitoring systems, each of the original event object having an original data format being particular for the type of IT monitoring system having generated the original event object, each original event object comprising one or more data values characterizing an event, the canonical event objects having a shared canonical data format, each canonical event object comprising a class-ID being indicative of the one out of a plurality of event classes to which its associated original event object has been manually and/or automatically assigned for handling the event represented by the original event object, the canonical event object comprising one or more attribute values derived from the data values of the associated original event object. Then the method executes a learning algorithm on the associated original and canonical event objects for generating a trained machine learning program adapted to transform an original event object of any one of the one or more original data formats into a canonical event object having the canonical data format and using the trained machine learning program for automatically transforming original event objects generated by an active IT-monitoring system into canonical event objects respectively being processable by an event handling system, the active IT-monitoring system being one of the one or more IT-monitoring systems or of a further IT-monitoring system.

In a further aspect, the invention relates to a computer system. The computer system may also be referred to as “training computer system”. The computer system may comprise a database comprising a plurality of original event objects respectively being stored in association with a canonical event object, where the original event objects being generated by one or more IT-monitoring systems, each of the original event object having an original data format being particular for the type of IT monitoring system having generated the original event object, each original event object comprising one or more data values characterizing an event, where the canonical event objects having a shared canonical data format, each canonical event object comprising a class-ID being indicative of the one out of a plurality of event classes to which its associated original event object has been manually and/or automatically assigned for handling the event represented by the original event object, the canonical event object comprising one or more attribute values derived from the data values of the associated original event object. The computer system may apply a learning algorithm of a machine-learning framework on the associated original and canonical event objects for generating a trained machine learning program adapted to transform an original event object of any one of the one or more original data formats into a canonical event object having the canonical data format.

In a further aspect, the invention relates to a computer system that comprise a trained machine learning program configured to transform original event objects having one or more original data format into a canonical event object having canonical data format, each of the original event objects comprising one or more data values characterizing an event, the canonical data format being processable by a local or remote event handling system, each of the original data format of each of the original event objects being particular for the type of IT monitoring system having generated the original event object. The trained machine learning program having an interface for receiving a new original event object from one or more active IT-monitoring systems, each of the active IT-monitoring systems, an interface to the local or remote event handling system, and a transformation coordination program adapted to use the trained machine learning program for automatically transforming the received new original event object into a new canonical event object having canonical data format, the canonical event object comprising one or more attribute values derived from the data values of the associated original event object and provide the new canonical event object to the event handling system for automatically handling the new event represented by the new canonical event object as a function of the attribute values contained in the new canonical event object.

### BRIEF DESCRIPTION OF THE SEVERAL VIEWS OF THE DRAWINGS

In the following embodiments of the invention are explained in greater detail, by way of example only, making reference to the drawings in which:

FIG. 1 Depicts a distributed event handling system comprising a trained event transformation program;

FIG. 2 Depicts a flowchart of a method for training an event transformation program;

FIG. 3 Depicts a flowchart of a method for using a trained event transformation program;

FIG. 4 Depicts a computer system for training an event transformation program;

FIG. 5 Depicts a program used during training the event transformation program; and

FIG. 6 Depicts a method of supplementing and improving training data.

### DETAILED DESCRIPTION

Embodiments of the invention may have the advantage of providing a system and method for handing events that may be particularly flexible and that may be able to process and automatically react to events generated by many different IT-monitoring systems. In particular, the system and method may be able to accurately process and interpret events generated by components of one or more IT-systems respectively monitored by one or more different IT-monitoring systems, whereby the type and combinations of these components and/or the type of IT-monitoring systems receiving messages of those components may be highly heterogeneous. For example, embodiments of the invention may be able to overcome some or all of the technical disadvantages associated with state-of-the art event management approaches.

Embodiments of the invention may be able to transform events, e.g. monitoring alerts, from different IT-monitoring systems into standardized events for automated downstream processing, e.g. the creation and/or management of tickets, the automated execution of software- and/or hardware modules to prevent or repair a technical problem having thrown the event, etc.

Many organizations maintain a variety of deployed software applications, a variety of different hardware components such as processors, network routers, storage devices, network storage servers, and optionally also a variety of IT monitoring system for monitoring these one or more hardware or software components. For example, an IT-monitoring system can be the IBM Tivoli Monitoring Program that requires events to be specified in an original data format referred to as “version 6 (ITM6)”. However, some system components may be monitored by tools other the IBM Tivoli Monitoring program, e.g. third-party monitoring tools that may add functionality in specific areas. The processing of events generated by these third-party IT-monitoring tools, e.g. for automated ticketing, notifications, or automatic resolution through dynamic automation may proof difficult as these events do not comply to the ITM6 format that can be interpreted by several event handling systems. For example, the ITM6 format requires an event to comprise a specific set of fields filled with a particular kind of information. The events generated by third party tools can comprise a different set of fields, and even in case some of the field names of an event of a third-party monitoring tool should be identical to the field names of an ITM6 format, these fields may be filled with data that is particular to the third party monitoring-tool and may not be interpreted by any ITM6-based event handler correctly.

Embodiments of the invention may allow to implement a standardized approach to manage events generated by many different IT-monitoring systems in accordance with many different formats, e.g. the ITM6 format and other, non-ITM6-compliant formats and to allow an automated, fully integrated downstream processing of all these events. In other word, embodiments of the invention may transform events of many different formats generated by many different IT-monitoring systems into a canonical data format that is used as the basis for automated event handling, e.g. for the purpose of system monitoring and control, for automated ticketing, and the like. Embodiments of the invention may provide for an event processing system and method that is agnostic to the IT-monitoring tool used for monitoring a plurality of IT software and/or hardware resources.

In a further beneficial aspect, embodiments of the invention may allow establishing the IT-monitoring-tool agnostic event handling system automatically or semi-automatically by means of a machine-learning approach. The trained ML-program can be generated on a training data set comprising of a plurality of original events (from one or more different IT-monitoring systems) and a set of canonical events respectively assigned to one of the original events. For example, the training data set can comprise a plurality of events generated by Nagios, an open source computer-software application that monitors systems, networks and IT infrastructure. Nagios offers monitoring and alerting services for servers, switches, applications and services. It alerts users when things go wrong and alerts them a second time when the problem has been resolved. Each event in the training data set has assigned an event specified in the canonical data format, e.g. the ITM6 format. By training a ML program on such a training data set, the format transformation logic can be created easily, quickly and fully automatically without requiring a programmer to explicitly specify format transformation routines in any source code.

Embodiments of the invention may allow transforming (“normalizing”) monitoring alerts (“events”) into standardized events (field and content of the field in accordance with requirements defined in a standard) which allows for standardized downstream processing regardless of the IT-monitoring tool having generated the monitoring alert.

Embodiments of the invention may improve the ability of integrating additional IT-monitoring tools and/or events of new, e.g. proprietary, original data formats by decreasing the time and effort necessary to integrate these tools or events in an existing event handling process. Instead of modifying, recompiling and re-deploying the code of an existing event handling framework, embodiments may merely re-train a ML-program on a training data set having been supplemented with pairs of original events having this unknown original data format and canonical events having the same or similar information content. Thereby, the overall ability to manage heterogeneous systems with different types of hardware and/or software components may be improved.

Embodiments of the invention may help keeping event handling and downstream processing standardized for a plurality of different IT-systems, IT-system components and respective IT-monitoring tools. This leads to reduced cost in development/maintenance of dynamic automation automata and other automation integration (e.g. ticketing and notifications), event-based data analysis and providing a cross-system monitoring solution. According to some embodiments, development process for automata have been observed to be accelerated by at least 10%.

According to embodiments, the original event objects in the database are generated by a plurality of IT-monitoring systems. The plurality of IT-monitoring systems can comprise IT-monitoring systems of two or more different types, whereby the original data format of original event objects generated by an IT-monitoring system is specific for the type of this IT-monitoring system. During the learning phase, the ML program learns to transform the original data formats of the original event objects generated by the two or more types of IT-monitoring systems into the shared canonical data format.

This may be advantageous as a large number of different types of IT-monitoring systems can easily be integrated provided the training data covers event data of the different IT-monitoring system types.

According to some embodiments, the training data comprises only original event objects generated by a single IT-monitoring system, e.g. an IT-monitoring system whose original event objects can be processed only partially by a particular event handling system. Providing a training data set comprising original event objects which cannot or can only partially be interpreted by an event handling system in association with canonical data objects basically conveying the same information as the respectively assigned original event object, it is possible to integrate this IT-monitoring system quickly and accurately into a downstream event handling workflow.

In many use-case scenarios, the training data comprising an association of original event objects and canonical event objects is readily available so there is no need for explicit specification and annotation of the canonical event objects. For example, in some use case scenarios, explicit format transformation routines hard-coded in a source code of a transformation program were sometimes used for integrating the original event objects of a particular IT-monitoring tool into an event handling workflow. A history database, e.g. a log file or directory, comprising the incoming original event objects and the canonical event objects created therefrom by the hard-coded program routine may be used as training data set for training the ML program. By combining the event transformation histories of two or more different IT-monitoring systems, training data may be provided that allows the automated generation of a trained ML program adapted to automatically perform the format transformation for two or more different types of IT-monitoring system without requiring a user to modify any program code.

For example, the ML program can be trained on a training data set on a computer used for training purposes and can then be transferred to another computer system that is used for transforming incoming original event objects into canonical event objects. For example, the transfer of the trained ML program can be performed via a network, e.g. the Internet, or via a portable data carrier, e.g. an USB stick or SD card. According to other embodiments, the same computer system can be sued both for training the ML program and for using the trained ML for performing the format transformations.

The one or more active IT-monitoring systems which generate the original event objects input to the trained ML program can be identical to the one or more IT-monitoring systems having provided the original event objects of the training data, can be a sub-set or super-set thereof or can be different IT-monitoring systems. The active IT-monitoring system should be of a type that was—alone or in combination with other IT-monitoring systems—used for generating the original event objects of the training data set.

According to embodiments, the using of the trained machine learning program comprises: receiving a new original event object from one of the IT-monitoring systems; using the trained machine learning program for automatically transforming the new original event object into a new canonical event object having canonical data format; and providing the new canonical event object to the event handling system for automatically handling the new event represented by the new canonical event object as a function of the attribute values contained in the new canonical event object.

According to embodiments, the using of the trained machine learning program for automatically transforming the new original event object into a new canonical event object comprises performing the transformation directly by the trained machine-learning program. This may have the benefit of hiding complexity from the user. For example, some machine learning approaches, e.g. some types of neural networks or support vector machines, act as “black box” that does not allow a user to receive an explicit transformation algorithm or heuristics used by the trained ML program.

According to other embodiments, the using of the trained machine learning program for automatically transforming the new original event object into a new canonical event object comprises: exporting, by the trained machine-learning program, one or more explicit event object transformation rules; inputting the explicit event object transformation rules into a rules engine; and performing, by the rules engine, the transformation of the original event object into the canonical event object in accordance with the input event object transformation rules.

Hence, the trained ML program may in some embodiments be used indirectly for transforming the original event objects into canonical event objects. This may have the advantage of enabling a user to understand and review the automatically learned transformation logic. This may provide the user with better control to understand, review, approve and/or modify an automatically learned transformation algorithm.

For example, there exist several rule extraction algorithms for various types of machine learning approaches that can be used for extracting an explicit transformation rule from the trained ML program. For example, Hailesilassie, Tameru, 2016, “Rule Extraction Algorithm for Deep Neural Networks: A Review” describes several rule extraction approaches from neural networks, including deep neural networks.

According to embodiments, the method further comprises generating a GUI that enables a user to modify and/or confirm the one or more explicit event object transformation rules. This may be beneficial as the user is enabled to understand, review, approve and/or modify an automatically learned transformation algorithm. In particular in case the training data set is small and/or biased, there may be a risk that the transformation algorithm implicitly learned by the ML program comprises errors. By identifying and exporting the learned rules, the user is enabled to review and potentially also amend the automatically extracted event format transformation rules, thereby ensuring that the transformation does not introduce any errors into the canonical event object that may result in an erroneous event handling workflow.

According to embodiments, the GUI enables the user to modify and/or confirm the one or more explicit event object transformation rules before the rules are input into the rules engine. This may be advantageous as according to embodiments, no event format transformation is performed by the trained ML program unless the user had the option to review, modify and/or approve a rule. Erroneous event handling may result in the generation of erroneous analytical results, and even the failure of the whole monitored IT-system or of components thereof. Hence, giving a user the opportunity to review and modify the event format transformation rules before they are executed may increase the quality of format transformation and the accuracy and reliability (robustness, availability) of the monitored IT-system.

According to embodiments, the class ID and the attribute values of at least some of the canonical event objects in the database have been specified by a human user manually. For example, the user may create some of the canonical event objects in the training data manually or correct errors in a set of automatically generated canonical event objects. This may be advantageous a user may flexibly supplement or correct any (completely or partially) incomplete or incorrect training data set. Increasing the quality of the training data set will increase the accuracy of the format transformation to be performed by the trained ML program.

According to some embodiments, the class ID and the attribute values of at least some of the canonical event objects in the database have been created automatically by the event handler. For example, the original data format of some original event objects may be partially interpretable by the event handling system. Some event handling systems are configured to represent any incoming original event as an internal data structure, e.g. a DOM (document object model) tree, as an XML file, as a JSON file or as a binary data object, and are configured to store the information encoded in this internal format on a non-volatile storage medium. These stored data structures are preferably stored in association with the original event objects from which they originate. The stored data structures can be used as partially complete or incomplete canonical event objects. Hence, some types of event handling systems can be adapted to correctly interpret at least one of the original data formats and to transform the original event objects having this format into a canonical event object that is at least partially interpretable by the event handler when performing some downstream processing steps of a workflow. Storing these internally transformed canonical events as part of the training data set can have the advantage of semi-automatically and quickly creating a comparatively large training data set. For example, in case some few fields of the original event format cannot be processed correctly by the event handling system, these fields in the internal data structure may be empty or may comprise non-standard-compliant data. In addition, or alternatively, log entries in the log of the event handler can be automatically transformed by a log transformation program into the automatically generated canonical event objects.

According to embodiments, the method further comprises preprocessing, e.g. by a pre-processing program or by a sub-module of the ML program, the received original event object. Then, the preprocessed original event object is transformed by the machine learning program into the new canonical event object. The preprocessing comprises:
i. applying one or more natural language processing (NLP) functions on the new original event object for extracting one or more data values contained in the new original event object; For example, an original event object can comprise a sentence specified in a natural language, e.g. “The disc drive DR1 of computer system TWEX2284 is more than 70% full”; the NLP functions may automatically identify names of objects (e.g. “DR1 and TWEX2284”) and/or object attributes (e.g. storage occupancy=70%”); this information regarding the type of fields and regarding the semantic meaning of the data value contained in a field can be used as input of the ML program during training and/or when using the trained ML program for format transformation; for example, the NLP functions may extract property value pairs such as {storage-device-ID=“DR1”, computer-system-ID=“TWEX2284” and storage occupancy=“70%”}; The NLP functions may comprise, for example, a parser, e.g. a syntax parser and/or a POS (part of speech) parser in combination with a dictionary of synonym terms (e.g. “disc drive” being synonym to “storage device”) when extracting name-value pairs from the original event object; and/or
ii. applying a parser on the new original event object for extracting one or more data values contained in the new original event object; for example, a POS parser and/or syntactical parser can be applied on one or more text sections contained in the original event object for identifying words or phrases having a particular syntactical function; and/or
iii. checking if the extracted data values comprise one or more distinct event class names; for example, the list of event class names can be user-defined and specified manually and/or can be extracted automatically during the training phase from the totality of canonical event objects and their respective class-IDs; if so, the extracted event class label is assigned to the extracted data value(s); for example, the extracted event class label can be provided as input to the trained ML program for enabling the ML program to assign this extracted event class label to the output canonical event object; and/or
iv. checking if the extracted data values comprise one or more distinct attribute names; for example, the list of attribute names can be user-defined and specified manually and/or can be extracted automatically during the training phase from the totality of canonical event objects and their respective attributes; if the extracted data values comprise one or more distinct attribute names, the pre-processing comprises assigning a data field name to the extracted data value, the data field name being chosen in accordance with the canonical data format; for example, the original data object may comprise a field having the attribute name “disc drive” while the respective field and attribute name of a canonical event object is “storage device”; Based on a dictionary of all attribute names of the canonical data format and their synonyms, data values in the original event object as well as their semantic meaning can be automatically identified and provided as input to the ML-program, thereby enabling the ML program to create a canonical event object comprising these data values in fields representing the same semantic concept as the position in the original event object from which the data value was derived; and/or
v. adding one or more data values extracted from the original event object by a parser and/or by a natural language processing function as attribute values and/or as event class name to the preprocessed original event object; even in case an extracted data value cannot be mapped to an attribute of the canonical data format, it may nevertheless be useful to assign these data values to the pre-processed original event data object input to the ML program. For example, the original event object may comprise the state of a network switch that connects the IT-monitoring system having provided the event to the program performing the pre-processing; the event may relate to a “disc-full” event that has no predefined relation to the state of a network switch and that therefore does not comprise an attribute “network switch state” in the canonical data format. However, it may happen that in a complex system, a particular state or configuration of a network switch may have an unforeseen effect on network connectivity, e.g. because of an erroneous system configuration or complex, unforeseeable system component interdependencies; in this case, providing the—presumably irrelevant—information regarding to the state of the network switch to the machine learning program that learns to correlate this data value with particular event types, embodiments of the invention may be used to reveal unknown system component interdependencies. Typically, these interdependencies are not desired and embodiments of the invention may be used for identifying and removing these interdependencies in order to make a complex IT system more consistent and reliable.

According to embodiments, the transformation of the received original event object into the new canonical event object comprises automatically computing a priority level as a function of the data values of the new original event object and storing the priority level as an attribute value in the new canonical event object.

According to embodiments, the method further comprises: analyzing, by the event handling system, the priority level of the new canonical event object for automatically prioritizing the new event in accordance with its priority level.

This may have the advantage of enabling the event handler to process canonical events having assigned a higher priority level prior to other events and/or to allocate more IT resources (e.g. CPU, storage and/or memory) to program routines processing canonical events having assigned a high priority level.

A “priority level” or “priority” as used herein is a data value, typically a numerical data value, which specifies the importance an event. In particular, the importance can be an importance in respect to the availability, accuracy and functioning of an IT component monitored by an IT-monitoring system. For example, a “disc full” event that affects a data storage used for storing temporary files required by an operating system can be assigned a higher priority level than a disc full event affecting a data storage used for backup purposes only, because in case the operating system is blocked from storing temporary files, the operating system and all software applications and other IT-components depending from the operating system may break down. For example, according to embodiments of the invention, the training data set used for training the ML program comprises canonical event objects having assigned a priority level. During the training, the ML program may learn that disc full events relating to a particular data store comprising the operation system should be assigned a higher priority level than disc full events relating to other data stores, e.g. a backup drive. It should be noted that the data store for the operating system and the data store for the backup may be based on the same type of hardware and may generate original disc-full events having the same original data format. The priority level in the respective canonical event objects in the training data set can be assigned by a user manually and can reflect the relevance of a particular IT-component for the overall IT-system that cannot be derived directly from the IT-component itself or from the generated original events. Hence, training a ML program on a training data set comprising some manually or automatically annotated priority levels may have the advantage of providing a trained ML program that is able to transform original event objects into canonical event objects that comprise an accurate indication of their technical relevance for the functioning of an IT-system (even in case this overall-relevance cannot be explicitly derived from the information contained in an original event object). Hence, the trained ML program may be particularly adapted and customized to the particularities of the IT system of an organization, because the ML program has not only learned the transform a disc-full event generated for a particular type of IT-resource into a canonical event object whose format is interpretable by an event handler, the ML program has also learned which ones of a plurality of IT sources (that may be of identical type) are—given the particular configuration and setting of the complex IT system that is monitored—of particular relevance. This may greatly increase the quality of event handling and may help to prioritize event processing accurately.

According to embodiments, the data values of the original event objects are selected from a group comprising:
an identifier (e.g. an IP address, MAC address, etc.) of a data processing system having triggered the generation of the original event; or
an operating system of a computer system having triggered the generation of the original event object (e.g. MS Windows 7, Linux of a particular version, etc.); or
time and date of the moment when the generation of the original event was triggered; or
a geographic location comprising the object having triggered the generation of the original event object (e.g. an identifier of a geographic region, a building, a room within a building, etc.); or
a numerical value or value range being indicative of the severity, size or priority of a technical problem; or
one or more string describing the event and or the data processing system or system component having triggered the generation of the original event; or
a mount point, i.e., the location in a file system that a newly-mounted medium was registered during a mounting process of the medium, wherein the mounting process is a process by which the operating system makes files and directories on a storage device accessible via the computer's file system; this can be an important information e.g. for events which are mounting-related events, e.g. mounting-failed events or mounting-completed events; or
an internal device ID, e.g. an internal device ID of a device having triggered the generation of the original event; or
a combination of two or more of the aforementioned data values.

According to embodiments, the attribute values of the canonical event objects are selected from the above-mentioned group of data values, also (as some or all of them are derived from these data values). The attribute values can be created from one or more of the data values by storing the one or more data values that together represent a semantic concept (an attribute) in a particular field of the canonical data object, whereby the field has a predefined meaning (it represents an attribute) according to the canonical data format. Thus, the data values of the original event objects are stored in one or more fields of the canonical event objects such that the information conveyed in the data values matches the predefined semantic meaning of the fields of the canonical data objects and can be interpreted by the event management system.

According to embodiments, the event class of the new canonical event object is selected from a group comprising:
a storage full event; the storage full event can relate to a logical and/or a physical storage and indicates that a particular storage is full to a certain percentage, e.g. 85%, or 90%, or 100%;
a network connection failure event;
a task queue full event;
a server unavailable event;
a timeout event of a request or command sent to a device;
a mounting event.

Automatically identifying a class-ID of an event may have the advantage that the ML program learns to automatically generate canonical event objects having a class-specific syntax, e.g. a class-specific set and order of attributes and fields with a defined semantic meaning to be used for storing respective attribute values. Some event handling systems support a set of predefined canonical event classes, whereby canonical events of a particular event class are required to comprise one or more attribute values in predefined fields. By automatically identifying both data values and their semantic meaning in the original event objects and by checking if at least one of the identified data values corresponds to a predefined canonical event class, the ML program can automatically create a canonical event object that corresponds to a class of canonical events supported and interpretable by the event handler.

According to embodiments, one or more of the event classes have assigned an event-resolution workflow definition. The event-resolution workflow definition is a specification of a computer-implemented workflow that is to be used for processing an event of a particular class of events. For example, the event-resolution workflow of a “storage full” event may be the automated allocation of additional storage in combination with the sending of a warning message to one or more users, e.g. the admin and/or users allowed to store data in the storage. To the contrary, the event-resolution workflow for a “server unavailable event” may involve an automated restarting of the server and/or automatically performing some status tests on the server to identify the underlying problem. For example, an event-resolution workflow definition can be a human and/or machine-readable file, e.g. an XML file, a Json file or the like. The event-resolution workflow definition can also be or comprise an executable used for performing the event-resolution workflow or parts thereof. The method comprises providing the event-resolution workflow definition associated with the event class of the new canonical event object to the event handling system for enabling the event handling system to automatically handle the new event by executing an event-resolution workflow in accordance with the provided event-resolution workflow definition.

According to embodiments, at least some of the canonical event objects in the training dataset respectively have assigned an event-resolution workflow definition that indicates a workflow that has been used by an event handling system in response to receiving a particular canonical event object, e.g. in order to control the mode of operation of an IT system or of a component thereof in reaction to the event indicated in the canonical event object. For example, the reaction may be adapted to counteract, remedy or otherwise respond to a particular event, e.g. a storage full event.

During the training, the ML program evaluates the pairs of original and canonical event objects and also the event-resolution-workflow definitions assigned to the respective canonical event objects. Based on this information, the ML program learns from the event-resolution workflows having previously—and presumably successfully—been used to react to an event, to predict an event-resolution-workflow specification that should be followed by any downstream event handling system in response to this type of event.

According to embodiments, the event-resolution workflow definitions are assigned to the canonical event objects in the database in an event-class specific manner. In other embodiments, the assignment is more fine granular and the event-resolution workflow definitions are assigned to the canonical event objects in a per-event basis. This allows generating a trained ML program that is able to predict the appropriate event-resolution workflow definition for a particular, currently received original event object, in a more fine-granular manner.

Training a ML program on a training data set with original and associated canonical event objects wherein at least some of the canonical event objects have assigned an event-resolution workflow definition of a workflow that was (successfully) used for resolving a particular event may be highly advantageous, because it is not necessary to specify explicitly, e.g. by means of manually defined assignment rules, which ones of the event resolution workflow definitions should be assigned to which ones of the canonical event classes. At first, in particular for highly complex IT systems comprising many different types of interconnected components and respective event types, a manual specification of the best event resolution workflow in response to a particular event would be highly time-consuming and often not possible due to the complexity of the system. Second, applicant has observed that not only the event type, but also trends, priority levels, and the amount of one or more attribute values may have an impact on the question which kind of event resolution workflow should be preferred. For example, in case of a storage full event indicating an occupancy level of 50% for a data storage with a low priority level, a particular company may have always addressed those events by ordering a larger storage device or one or more additional storage devices. In case of a storage full event indicating an occupancy level of 90% for the same data storage, this particular company may in the past always have addressed those events by automatically performing some storage cleaning functions which automatically identify and delete temporary files or other files that are not required any more. Provided these different, company specific event resolution workflows are covered by the training data set, a machine learning program having been trained on this training data set is able to automatically assign an event resolution workflow definition to any newly created canonical event object that corresponds to the event resolution strategy this company has already successfully performed in the past.

The example also shows that the same type of event (storage full event) may be assigned to different event resolution workflow definitions if one or more of its attribute values (e.g. occupancy level: 50% or 90%) are different or if the canonical event objects have assigned different predicted trends or priority levels. Hence, the trained ML program can be configured to generate different canonical event objects of the same event class which may have assigned different event resolution workflow definitions independence on their attribute values and/or independence on predicted trends and priority levels assigned to these canonical event objects, if any. This may be advantageous, because these features enables the event handling system to react to many different situations and events highly flexibly and in a fine granular manner.

In a further beneficial aspect, embodiments of the invention allow to automatically and highly flexibly process a plurality of different events using event resolution workflows which are specific for a particular organization. The question, if storage shortage should be remedied by buying additional hardware or by deleting some data strongly depends on the goals an organization tries to achieve by means of the hardware and on the type of data stored. By providing a training data set comprising data of original events and canonical events (and respectively assigned event resolution workflows) that are specific for a particular organization, e.g. because the training data comprises event and event resolution workflow history data of this organization, a program that is able to automatically transform current alert messages into canonical data objects having already assigned a recommended event resolution workflow definition that can be assumed to fit best to the needs of a particular organization can be created quickly. It is merely required that a machine learning program is trained on the set training data set.

To give a concrete example, a training data set is provided that comprises multiple, company specific subsets.

A first subset of the training data set comprises event history data of a Canadian company that has been collected for over 1.5 years. The first subset comprises original event objects having Icinga 2 original data format. These original data objects respectively have assigned a canonical event object having IBM Network Management canonical data format. All original and canonical event objects comprise an event time. At least some of the canonical data objects have assigned priority level and an event-resolution-workflow specification that at least partially refracts some preferences of the Canadian company. The canonical event objects, the priority level in the event resolution workflow specifications have been specified and assigned to the respective event objects manually.

A second subset of the training data set comprises event history data of a Swiss company that has been collected over six months. The second subset comprises original event objects having SCOM original data format. These original data objects respectively have assigned a canonical event object having IBM Network Management canonical data format. Again, at least some of the canonical data objects have assigned a priority level and an event resolution workflow specification. However, in this case, the canonical event objects, the priority level in the event resolution workflows have been created and assigned automatically by means of a set of manually specified rules that have been executed by a rules engine.

A third subset of the training data set comprises event history data of a Dutch company that has been collected over six months. The original event objects have SCOM original data format. The canonical event objects have IBM Network Management canonical data format. As described for the second subset, the canonical event objects, priority levels and predicted trends are created by means of rules. However, the Dutch company uses other event resolution workflow definitions than the Swiss company and also priorizes events differently.

A fourth subset of the training data set comprises event history data of a French company that has been transforming original event objects specified as Nagios events for more than 3 years into IBM Network Management canonical data format.

By training and machine learning program on this heterogeneous training data set, the trained ML program may be able not only to correctly transform event objects specified in many different original data formats into a common, canonical data format. The trained ML program is in addition able to assign to each of the canonical event objects a predicted priority level and/or event resolution workflow definition that corresponds to an organization-specific strategy or requirement. Thereby, the trained ML program preferably does not only take into consideration particularities syntactically implied by the different data formats, but also particularities that are implicit to the naming conventions and technical properties of a particular IT system of a company.

For example, the Canadian company may use names according to the pattern DB[0-9] [0-9] [0-9] [0-9] as identifiers for database servers and may use names according to the pattern SRV[0-9][0-9][0-9][0-9] as identifiers of server computers acting as application service providers, wherein the expression “[0-9]” represents any single digit number from 0 to 9. All database servers may use Linux as operating system and all application server computers may use Windows. All network routers have assigned an identifier starting with the character “R”, followed by a 10-digit number.

To the contrary, all computers of the French company may have Linux as operating system and may have an indicator starting with two characters “CS” followed by a six digit number. All network routers have assigned an identifier starting with an 8-digit number, followed by a department-ID, followed by a suffix “NR1”.

According to embodiments, the trained ML program has learned to identify, based on the syntax but also based on organization specific naming conventions and other information implicitly or explicitly expressed in the original event objects, to identify attribute values of particular attributes in the original data format. In some cases, it is possible to derive the type of an IT-system component already from the naming convention used by a particular organization. In this case, the training data can be at least partially incomplete.

According to embodiments, the method comprises providing a training dataset with a plurality of original event objects and respectively assigned canonical event objects, whereby the canonical event object comprises at least one attribute field that does not comprise a corresponding attribute value; enabling a user to supplement at least some of the canonical data objects in the training data set by writing an attribute value in the at least one field, and/or to assign a predicted trend, priority level and/or an event resolution workflow to this canonical event object; storing the supplemented data provided by the user in the training dataset to create a supplemented version of the training data set; and re-training the trained ML program on the supplemented training data set. These steps may be repeated multiple times, thereby iteratively supplementing the training data set and improving the accuracy of the ML program.

According to embodiments, the trained ML program or a framework for performing the training of the ML program is configured to automatically analyze if the canonical event objects in the database that have been used as training data comprise a value for all attributes of a canonical event of a particular event class in accordance with the canonical data format. For example, the canonical data format may imply that an event of type “storage full” requires at least the attributes “storage-ID”, “percentage occupancy” and “file system”. However, the analysis may reveal that the field of the “file system” attribute is empty in some or all canonical event objects in the training data set, e.g. because the event handling rules that were used for transforming original event objects into canonical event objects for creating the training data set were not able to extract the respective information from the source event objects or because the IT monitoring system having provided the original event objects was not able to recognize the “file system” attribute value. The framework or another software application instantiated on the training computer system is configured to automatically analyze the canonical event objects for determining if some or all canonical event objects lack some attribute values required according to the canonical data format. If so, the software having performed this analysis can optionally send an alert, e.g. a message box on a GUI, an e-mail or the like, to a user requesting the user to specify at least some of the missing attribute values of the canonical data objects manually and/or to apply the trained ML program on the original event objects in the training dataset to created updated versions of canonical event objects in the training dataset. In response to receiving the alert, the user may manually supplement the missing attribute values in at least some of the canonical event objects and/or manually apply the trained ML program on the original event objects of the training dataset to create the updated and complete canonical event object versions. The generation of the alert is an optional step. In some cases, the framework of the other software application having performed the analysis may automatically, upon determining that at least one of the canonical event objects lacks some attribute values required according to the canonical data format, automatically apply the trained ML program on the training data, thereby transforming the original event objects of the training data into updated versions of canonical event objects, whereby some or all of the updated versions of the canonical event objects comprise the attribute values the at least one canonical event object was lacking. As a result, the updated canonical event objects will comprise the attribute value(s) that is(were) missing in canonical event objects in the originally provided training dataset. Then, the already trained ML program is re-trained on the training dataset comprising the updated version of the canonical event objects. Thereby, a re-trained and typically more accurate trained ML program is provided.

These steps of re-applying the ML program on the training dataset in order to create updated, more complete versions of the canonical event objects in the training dataset and re-training the ML program on the updated version of the training dataset may be performed multiple times, thereby iteratively improving both the quality of the training data set and the accuracy of the trained ML program.

Hence, each event type, the training framework or the other software program may analyze which attributes are required for a particular event or event class according to the canonical data format, and if an attribute value is required but missing in the canonical event objects in the training dataset, the already trained ML program is used for transforming the original event objects in the augmented versions of the canonical event objects to include the missing information.

This may be advantageous as the ability of the ML program to transform original event objects into canonical event objects can be iteratively improved with minimum time and effort.

For example, the user may be provided a GUI enabling the user to manually edit a canonical event object, e.g. manually specify one or more attribute values that the user can derive from the original event object but that could not be extracted by the trained ML program. In addition, or alternatively, the user may assign a predicted trend, a priority level and/or an event resolution workflow description he or she considers appropriate. By re-training the ML program on the supplemented training dataset, a re-trained ML program is provided that is able to now correctly identify the data values in the original event objects that are to be extracted and stored in the one attribute field that the previous version of the ML program was not able to fill automatically.

For example, the canonical data format for a particular event class generated by server computers may require the attribute “server-name”. However, the original event objects generated by or for the database servers of the Canadian company may not comprise a field “server-name” required as attribute according to the canonical data format. Rather, the original data objects may comprise the field “ID” respectively filled with a name following the pattern SRV[0-9][0-9][0-9][0-9]. The canonical data objects assigned to the original data objects may comprise an empty attribute field “server-name”. Hence, the training data set is incomplete. This situation may occur quite often e.g. when a manual or semi-automagical algorithm or rule is executed in order to create the canonical event objects but this algorithm or rule fails to correctly parse and process all data values in the original event objects.

When the ML program is trained the first time on this “incomplete”/“low quality” training data set, the ML program may not be able to correctly determine that the names of the pattern SRV[0-9][0-9][0-9][0-9] correspond to the attribute “server-name” required by the canonical data format. Hence, the ML program created based on this incomplete program may be able to create canonical event objects which are also incomplete and miss some attribute values.

However, supplementing only a few of the incomplete canonical event objects with additional information (that may e.g. be provided manually by a user) and retraining the ML program on this slightly supplemented training data set may be sufficient to significantly improve the capability of the ML program to transform an original event object into a canonical event object: for example, the field “ID” of the original event objects of the Canadian company is always filled with the name following the pattern DB[0-9][0-9][0-9][0-9] or SRV[0-9][0-9][0-9][0-9]. When a user manually supplements only some (e.g. less than 20, e.g. less than 10) canonical data objects by filling the field “server-name” with the name like DB9238 or SRV7288 specified in the respective original event object, the ML program learns, during the re-training, that the attribute value for the required attribute “server-name” can be found in a particular position in the original event object, i.e., in the field “ID”. The ML program may also use the company-specific naming convention as an indicator whether a particular data value represents a required attribute.

To give a further example, a disk-full event from ITM6 would require one or more attributes and respective attribute fields within the original event object to be filled to classify the event as a disk full event and to enable the event handling system. A complete original ITM6 event object is required to specify which disk (name) the event is for, as well as the current utilization and the threshold percentage it breached. Filling out the data fields in the original event object with exactly the same information and format would also apply for a disk full event coming from Nagios or any other monitoring tool. However, within the M&E Netcool Event Management tool, which may act as super-IT-system-monitoring tool that may collect the original events from the Nagios and the ITM6 IT monitoring tool, these fields are filled in the same way and from there it can't be determined anymore from which monitoring sub-system and tool the event originated. However, other fields of the original event objects provided by the Netcool E&M tool may still hold information specific to the monitoring tool that may allow reconstructing the identifier of the original system and system component. The automated transformation of original event objects into canonical event objects according to embodiments of the invention allows for standardized downstream processing regardless of where the monitoring alert came from or what technology was used. This may improve the adaptability to new alert formats (decrease effort, increase quality and increase speed to integrate) and may improve the overall ability to manage heterogeneous system with different types of event sources.

According to embodiments, the ML program comprises an event classifier adapted to identify one out of a predefined set of event classes an original event object belongs in dependence of the data values contained in the original event object and to use the identified event object to assign the class-ID to the canonical event object generated by transforming the original event object. In addition, the ML program comprises a data value classifier adapted to identify one out of a predefined set of attribute types a data value contained in a original event object belongs, the determination being performed in dependence of the position and combination of data values contained in the original event object, and to store the classified data values as attribute values at predefined positions in the canonical event object generated by the transformation of the original event object. For example, the data value classifier may be used for determining if a data value in a particular data field in an original event object is one of “source-ID”, “source-Name”, “event-date”, “event-time”, and “storage full”. The first four data value can be used for identifying attribute values of the canonical data format, e.g. attributes like “source identifier”, “source name”, “time”, whereby the attribute “time” may be built by combining the data values “event-date” and “event-time”. None of the first four data values is particular to a specific event class. Therefore, these data values can typically not be used by the ML program for predicting the event class. However, the identified attribute “storage full” may be a strong indicator that the event is a “storage full” event. The “storage attribute” can be used by the event classifier to automatically predict the event class of the canonical event object to be generated and to create a canonical event objects comprising all attribute fields necessary for a canonical event object belonging to this particular class.

Automatically classifying events may be beneficial as this feature provides insight where monitoring is done in duplications or where monitoring may be missing. In addition, this feature may allow comparing the monitoring of the classified events against GSMA monitoring best practices. Furthermore, automatically classifying events from the plethora of event sources used in complex IT-monitoring systems in particular hybrid cloud monitoring systems, decreases boarding time and effort from years/months to days. It avoids the need for manually mapping events upfront and maintenance thereafter when events changes (or when a different monitoring tools is used).

The computer system comprising the framework for training the ML program can also be referred to as “training computer system”. The training computer system can be a monolithic computer system, e.g. a standard computer system, or a distributed computer system comprising one or more processing units, one or more storage units and memory components connected with each other via a network.

The computer system comprising the trained ML program that is configured to process original event objects received from one or more active IT-monitoring systems can also be referred to as “event transformation computer system”. The monitoring computer system can be a monolithic computer system, e.g. a standard computer system, or a distributed computer system comprising one or more processing units, one or more storage units and memory components connected with each other via a network. According to some embodiments, a computer system is used both as training computer system and as event transformation computer system. According to other embodiments, the training computer system and the event transformation computer system are different computer systems and the trained ML program has to be transferred from the training computer system to the event transformation computer system. According to some embodiments, the training computer system in addition comprises or is operatively coupled to an event handling system that may be used for providing or enhancing some of the training data. According to some embodiments, the event transformation computer system in addition comprises or is operatively coupled to an event handling system that receives the canonical event objects generated by the trained ML program.

A “database” as used herein is a collection of electronic information (“data”) that is organized in memory or on a non-volatile storage volume. For example, a database can be a file or a directory comprising one or more files. According to some embodiments, the database has the form of a particular, defined data structure which supports or is optimized for data retrieval by a particular type of database query. The data is typically logically organized in database tables. A database can in particular be a relational database, e.g., a column-oriented database or a row-oriented database.

A “database management system (DBMS)” as used herein is a software application designed to allow the definition, creation, querying, update, and administration of databases. Examples for DBMSs are IBM Db2 for z/OS, MySQL, PostgreSQL, IBM Db2 Analytics Accelerator (IDAA), and others.

A “module” as used herein is a piece of hardware, firmware, software or combinations thereof configured to perform a particular function within an information-technology (IT) framework. For example, a module can be a standalone software application, or a sub-module or sub-routine of a software application comprising one or more other modules.

An “event” as used herein is an action or occurrence recognized by a software- and/or hardware-based IT-system. For example, each of a plurality of components of an IT-system may be configured to asynchronously generate an event in the form of an alert message or status message, that may be handled by software. Computer events can be generated or triggered by the system, by the user or in other ways. According to embodiments, the workflows performed by the event handling system can be configured to process at least some of the events synchronously with the event handling process flow, that is, the event handling workflow may have one or more dedicated places where events are handled, frequently an event loop. A source of events includes the user, who may interact with the software by way of, for example, keystrokes on the keyboard. Another source is a hardware device such as a timer, a CPU, a disc, a network switch or the like. Software can also generate events, e.g. to communicate a status change of a system component and/or the completion of a task.

A “event object” as used herein is a data structure comprising data values being descriptive of some aspects of an event.

An “event class” as used herein is an indication of a particular type of events. For example, the event handling system may be able to process events belonging to a limited set of predefined event classes such as “disc full event”, “network failure evet”, “memory shortage event”, “backup process completed event”. According to embodiments, each event class corresponds to a respective, unique set of attributes and the trained ML program is configured to transform original event objects which are determined to be member of a particular event class such that at least all mandatory attribute fields in the canonical data format specific to this event class are filled with the corresponding data values.

An “original event object” as used herein is an event object comprising data values specified in accordance with a data format referred to as “original data format”. The original event object can be generated, for example, by an IT monitoring system or by a system component of the system monitored by the IT-monitoring system. According to embodiments, the original event object generated by a particular IT monitoring system cannot be (correctly) interpreted and processed by an event handling system as the event handling system does not support the original data format of the original event object.

A “canonical event object” as used herein is an event object comprising data values specified in accordance with a data format referred to as “canonical data format”. The canonical event object can be generated, for example, by a ML program that automatically transforms an original event object into the canonical event object such that at least some or all information encoded in the original event object is also contained in the canonical event object. According to embodiments, the canonical event object can be (correctly) interpreted and processed by an event handling system as the event handling system supports the canonical data format of the canonical event object.

An “original data format” as used herein is a data format of an event object that specifies the type of data values that have to be contained in an original event object and, optionally, the position and/or names of these data values in the original event object. For example, the original data format can be a document type definition (DTD) that defines the valid building blocks (e.g. data fields or XML elements) of an electronic document. The original data format is defined by the instance creating the original event object, i.e., an IT component or an IT-monitoring system. The original data format can be a proprietary format particular to the IT component or an IT-monitoring system.

A “canonical data format” as used herein is a data format of an event object that specifies the type of data values that have to be contained in an original event object and, optionally, the position and/or names of these data values in the original event object. For example, the canonical data format can be a document type definition (DTD) that defines the valid building blocks (e.g. data fields or XML elements) of an electronic document. The canonical data format is the data format required by an event handling system for enabling the event handling system to correctly interpret and process an event object. The canonical data format can be a proprietary format particular to the event handling system.

According to embodiments, the canonical data format is a data format that is interpretable by the event handling system, wherein the original data formats (of the original event objects in the training data and/or of the active IT-monitoring system(s)) are data formats that are nor interpretable or only partially interpretable by the event handling system.

An “IT monitoring system” as used herein is a software application and/or hardware component that monitors IT systems and/or IT system components. An IT-component can be any software or hardware component of an IT system. For example, an IT component can be a computer system, a CPU, a logical or physical storage device, memory, a gateway, a switch, a network and any other hardware component as well as software programs, e.g. a web server program, an application server programs, an application program, etc. Examples of IT monitoring systems are ITM6, Icinga 2, and Nagios.

A “data value” as used herein is a piece of information with respect to a qualitative or quantitative property, e.g. in respect to a property of an IT-component. The data value can be specified in the original event object in any form, e.g. as natural language text, as a property field value, as a property-value list or combinations thereof. The data values of an original data object can comprise a mixture of data values created by the IT-component having originally created the original event object ad some additional data values added by the IT-monitoring system having received and further processed the original event object before forwarding the processed original event object to the trained ML program.

An “attribute value” as used herein is a piece of information with respect to a qualitative or quantitative property, e.g. in respect to a property of an IT-component, whereby the name and/or position of the value within a canonical data object complies with a set of attribute-related requirements of the canonical data format. For example, the canonical data format may require that a canonical event of a particular event class must comprise a corresponding attribute value in a particular set of attribute-specific data fields. According to embodiments, attribute values are data values stored at defined positions and/or in association with defined attribute names in a canonical event object in accordance with the canonical data format.

A “machine learning program” or “ML program” as used herein is a software program or module capable of performing a data processing task (e.g. prediction, classification, data transformation, etc.) effectively without using explicit instructions, relying on patterns and inference learned in a training phase instead.

According to embodiments, a machine-learning framework is configured and used to apply a learning algorithm on the associated original and canonical event objects for generating a trained machine learning program adapted to transform an original event object of any one of one or more different original data formats into a canonical event object having the canonical data format.

An “event handling system” as used herein is a software and/or hardware-based system configured for processing events fully or semi-automatically, typically with the aim of keeping a technical system, in particular an IT-system, up-and running and/or ensuring that a particular technical workflow currently performed by the technical system can continue without interruptions and failures. For example, the workflow can be a production workflow for manufacturing a particular good. The event handling system preferably has the ability to control the operation of at least some of the components of the technical system and/or to control at least some workflow steps in dependence on the information content of events that are dynamically received from the said technical system. For example, the IT-system controlled by the event handling system can be the IT system monitored by an IT-monitoring system that provides original event objects to the trained ML program.

Examples of an event handling system are IBM Netcool Impact (for real-time automation, event preparation and business impact analysis), IBM Business Service Management (a service management system for monitoring business processes, services and SLAs), IBM Network Management (for real-time detection, monitoring and topology of Layer 2 and Layer 3 networks), IBM Netcool Configuration Manager (for automating configuration and change management tasks), IBM Operations Analytics—Log Analysis Managed (for detecting and resolving problems through rapid analysis of all operational data), IBM Runbook Automation (for automation of common tasks and faster resolution of common operating errors), and IBM Alert Notification (SaaS) and combinations of two or more of the aforementioned event handling systems.

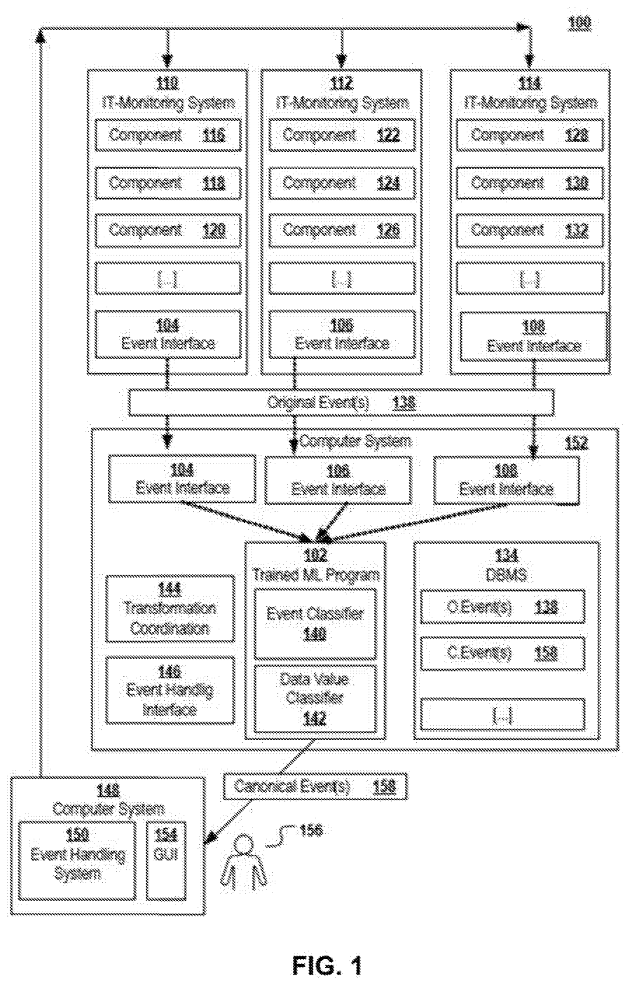

FIG. 1 depicts a distributed event processing system 100 comprising a trained event transformation program 102. The system 100 can be used e.g. for performing a method illustrated in FIG. 3.

The system 100 is a distributed computer system that comprises a computer system 152 with a trained ML program 102. For example, the system 100 can be a cloud computer system or a standard, single server computer. The trained ML program 102 comprises one or more interfaces 104, 106, 1084 receiving original event objects from one or more IT monitoring systems 110, 112, 114 connected to the computer system 152 via a network, e.g. the Internet. Each monitoring system 110, 112, 114 comprises and/or is configured to monitor a set of hardware and/or software components 116-132. For example, IT monitoring system 110 is configured to monitor the state of components 116-120 and to send original event objects 138 generated by one or more of the components via event interface 104 to the trained ML program 102. The number and type of components monitored by the respective IT monitoring systems 110-114 can be identical or can be different from each other. The different monitoring systems 110-114 can be of the same type, and will in this case create original event objects having the same type of original data format. However, it is also possible, that the different IT monitoring systems are of different type. For example, system 110 could be the IBM Tivoli Monitoring ITM 6.X Platform (“ITM6”), system 112 could be Nagios (a free and open source computer-software application that monitors systems, networks and infrastructure such as servers, switches, applications and services to alerts users when things go wrong and when the problem has been resolved), and system 114 could be Icinga 2, an open source monitoring system which checks the availability of network resources, notifies users of outages and generates performance data for reporting across multiple locations (Asay, Matt, 6 May 2009, “Open-source working as advertised: ICINGA forks Nagios”, CNET).

In many embodiments, IBM® Tivoli® Monitoring products are used as IT-monitoring systems for semi-automatically or automatically monitoring and optionally also controlling the operation and state of a complex IT-system and its components. The Tivoli Monitoring products can be used for deploying and preparing to install, upgrade, or configure software components of an IT-system. IBM Tivoli Monitoring products monitor the performance and availability of distributed operating systems and applications. These products are based on a set of common service components, referred to collectively as Tivoli Management Services. Tivoli Management Services components provide security, data transfer and storage, notification mechanisms, user interface presentation, and communication services.

When integrating events of many different IT-monitoring systems, the problem arises that fields in an alert (e.g. alert key) are filled with monitoring-tool-dependent.

information. This does not allow for a standardized approach to create automation rules and/or mapping within Dynamic Automation. Also, important information may be missing as it is currently not provided in the alert. Embodiments of the invention may provide for a “hybrid cloud monitoring tool agnostic event model” by automatically transforming any incoming original event object into a normalized, canonical data format. This will allow for generic creation of automation rules. Standardization of these events will also facilitate cross monitoring tool analytical insights, correlation of events and identify opportunities for further automation (e.g. IBM's Dynamic Automation).

The computer system 152 comprises one or more processes and a non-volatile storage medium comprising the trained ML program 102 and some additional software modules 144 and interfaces 146. Preferably, the computer system 152 comprises or is operatively coupled to a DBMS 134 comprising one or more databases. For example, the databases can comprise a history of original event objects 138 received from the one or more IT monitoring systems 110-114 and a history of canonical event objects having been created by the trained ML program from the dynamically received original event objects 138. The computer system 152 or a component thereof, e.g. the transformation coordination program or program modules 144, uses the trained ML program 102 for automatically transforming original event objects 138 received dynamically at runtime of the trained ML program from the one or more active IT-monitoring systems into canonical event objects respectively being processable by the event handling system 150. the event handling system 150 can be a software program or framework configured for handling events, e.g. in order to automatically execute an event processing workflow. The event processing workflow can represent and/or control, for example, the manufacturing a good, the performing of a quality check on a physical object, e.g. a manufactured good, or for controlling the operation of the one or more components 116-132 in such a way that system failures and/or long response times of the one or more components monitored by the IT monitoring system having provided the original event are prevented. The event handling system 150 can comprise a graphical user interface 154 enabling a user 156 to inspect the canonical event objects received from the trained ML program, e.g. in order to be informed on the type of alerts that has been generated and on the identity of the affected components. The GUI may also enable the user to monitor the event processing workflow performed by the event handler 150 and/or to modify an ongoing event handling process. the event handling system 150 can be an application program that is hosted on a separate computer system 148 connected to the computer system 152 comprising the trained ML program via a network. In other embodiments, the event handling system 150 can be hosted on the same computer system 152 as the trained ML program 102.

As illustrated in FIG. 3, the trained ML program 102 can comprise or be operatively coupled via an event interface 104, 106, 108 to one or more IT monitoring systems 110, 112, 114 over a network.

In a first step 302, the trained ML program 102 receives an original event object that has been generated by one of the one or more active IT monitoring systems 110-114. The received original event object 138 comprises a plurality of data values which are descriptive of details of when event, e.g. are descriptive of the name, the type and/or location of a particular data store where a storage full event occurred. The original event object may comprise further data values being indicative of related aspects such as the file system of the data store, a particular user in charge of maintaining the data store, one or more identifiers of users having write access to the data store and which need to be informed of the storage full event, a percentage value being indicative of the degree of occupation, and the like. The data values being descriptive of the event are specified in an original data format that is particular to the IT monitoring system having sent the original event object to the ML program 102. The event handling system 150 in charge of handling events may not be able to process and interpret the syntax of the original event object correctly. For example, the event handling system may expect some particular data values to be stored in a field at a particular position within an event object and/or under a field-name that differs from the field position and/or field name of the original event object comprising the respective information.

Next in step 304, the trained ML program 102 is used for automatically transforming the received original event object into a respective canonical event object that is processable by the event handling system 150. For example, the receiving of the original events, and the starting of the event object transformation by the ML program 102 can be coordinated by the transformation coordination program 144, which can be a standalone software application that is interoperable with the trained ML program, or can be a module of a software application that comprises or is interoperable with the trained ML program.

According to some embodiments, the trained in a program 102 comprises a data value classifier 142 configured to identify the semantic meaning of a particular data value and use this information to create attributes of the canonical event objects. In some example embodiment, this data value classifier has in addition learned during the training phase of the ML program which ones of the data values of an original data object are of particular relevance, e.g. for predicting a trend, a priority level and/or an event resolution workflow definition that should be assigned to a canonical event object created from the original event object. Recognizing which features are informative may allow the ML program to determine which ones of the data values of an original event objects are relevant and are processed for extracting the attribute values that are required by the event handler. The event handler expects to receive at least some or all of the attribute values of an event of a particular class.

In addition, the ML program can comprise an event classifier 140 adapted to automatically determine, e.g. based on one or more data values of the original event object, the event class this original event object and hence also the canonical event object derived therefrom belongs to.

As a result of the transformation, the trained ML program outputs a canonical event object 158 that comprises some or at least a subset of the information contained in the received original event object, whereby the information as specified in a canonical data format that can be interpreted and processed by the event handling system 150. Optionally, the system 152 stores the dynamically received original event object 138 and the canonical event object 158 created therefrom in an event object history database managed by the DBMS 134.

Next in step 306, the computer system 152, e.g. the trained ML program 102 or the transformation coordination program 144 forwards the created canonical event object 158 via an event handling interface 1462 in the event handling system 150.

Next in step 308, the event handling system analyzes the received canonical event object 158 and controls the operation of one or more components 116-132 of the IT monitoring system from which the original event object was received in dependence on the result of the analysis. For example, the event handling system 150 is configured to handle any incoming canonical event object as a function of the attribute values contained in the new canonical event object. This means that the number, type and/or sequence of workflow steps that are executed or triggered by the event handling system 150 depend on the attribute values and the event class of the received canonical event object 158. For example, in case the canonical event object indicates that a storage full event occurred at a particular logical storage volume with the attribute value “component-ID=D2352”, the event handling system may automatically assign additional storage space to this particular storage volume. If the attribute “component ID” would comprise the value “D2384”, the additional storage space would be assigned to the logical volume “D2384”.

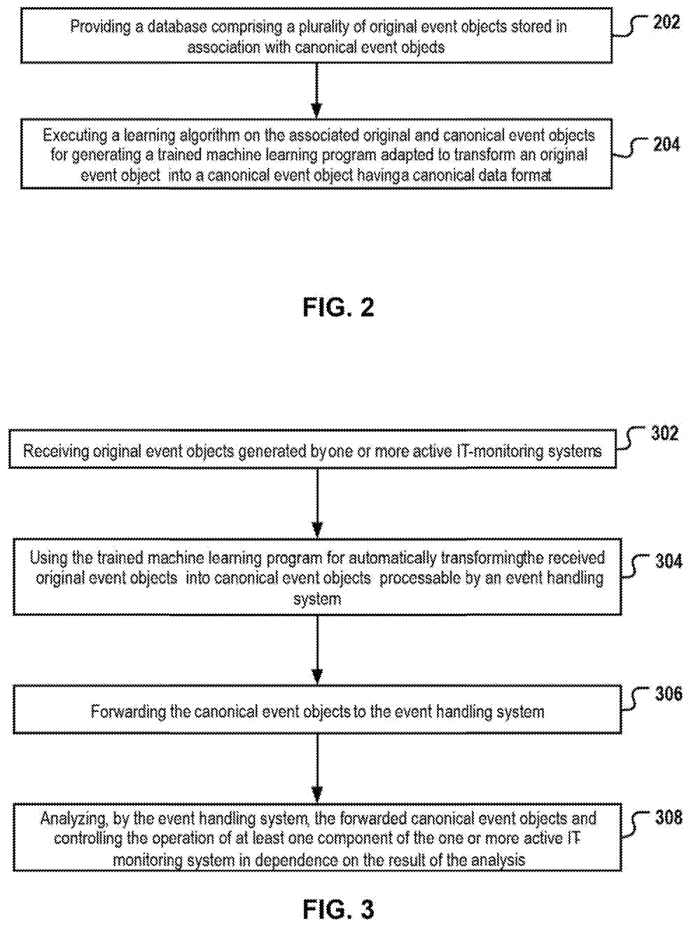

FIG. 2 depicts a flowchart of a method for training an event transformation program.

First in step 202, a database comprising a plurality of original event objects is provided. For example, the database can be a relational database such as a MySQL or PostgreSQL database. Likewise, the database can simply be a directory comprising one or more files. In addition, a plurality of canonical event objects is stored in the database in association with the one of the original data objects from which it was derived. The original event objects and their associated canonical event objects are used as training data.

A training dataset is a dataset of examples used for learning, whereby the data records in the training data set are known to be (at least mostly) correct. So the canonical data objects in the training data set comprise all or most of the attribute values in the data fields where the data values are expected according to the canonical data format. In addition, the attribute values of the canonical data objects (at least mostly) correctly reflect the information and semantic meaning encoded in the data values in the assigned original event object in accordance with the original data format.

Next in step 204, a machine learning program is trained on the training data.

During the training, the ML program learns existing statistical relationships between the fields, field names, the data values contained in the said fields, the syntax of the data values and/or the field position in the original event objects and the fields, field names, the attribute values contained in the said fields, the syntax of the attribute values and/or the field position in the respectively assigned canonical event objects. The training phase (or “learning phase” comprises the automated construction of algorithms (or “models”) that have learned—based on the information encoded in the training data—to make predictions on input data that is of identical or similar structure like parts of the training data. In other words, a trained ML program has learned to make data-driven predictions how and where a particular data value in an original event object needs to be positioned and specified such that the resulting “canonical” event object complies with a canonical data format that is interpretable by a particular event handling system.

The data used to build the final model usually comes from multiple datasets. In particular, three data sets are commonly used in different stages of the creation of the model.

The training dataset can consist of pairs of an original event object and the corresponding canonical event object created in a manual or automated transformation process from the original event object. During the training, a current model of the ML-program is run with the training dataset and produces a result, e.g. a prediction on how a canonical event object that is derived from an input original event object looks like. This “predicted” canonical event object is then compared during the training with the “true” canonical event object that is actually assigned to the input original event object in the training dataset. Based on the result of the comparison and the specific learning algorithm being used, the parameters of the model are adjusted (“model fitting”). Then, the trained ML program obtained in the training phase can be used for automatically transforming dynamically received original event objects into canonical event objects. The dynamically received original event objects are not contained in the training dataset and may be provided by a different IT-monitoring system whose original event objects have not been contained in the training dataset.

As a result of the training, the trained ML program has learned to dynamically analyze an original event object in order to automatically determine the type (or “class”) of the event, to extract the data values from all data fields considered to comprise relevant information, and to automatically create a canonical event object that comprises the extracted data values in the form of attribute values at the appropriate position in accordance with the canonical data format.

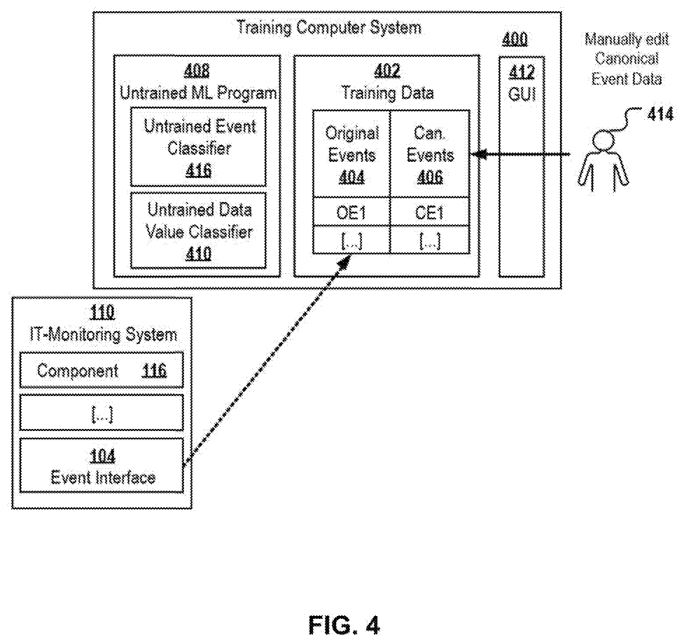

FIG. 4 depicts a computer system 400 used for training an event transformation program referred herein as trained ML program 102. The system comprises a training dataset 402 comprising pairs of original data objects 404 and canonical data objects 406 created therefrom. The system further comprises a GUI 412 enabling a user to create or modify the training dataset, e.g. by manually creating canonical event objects which basically comprise the same or similar information as the original event objects but are specified in a canonical rather than the original data format.

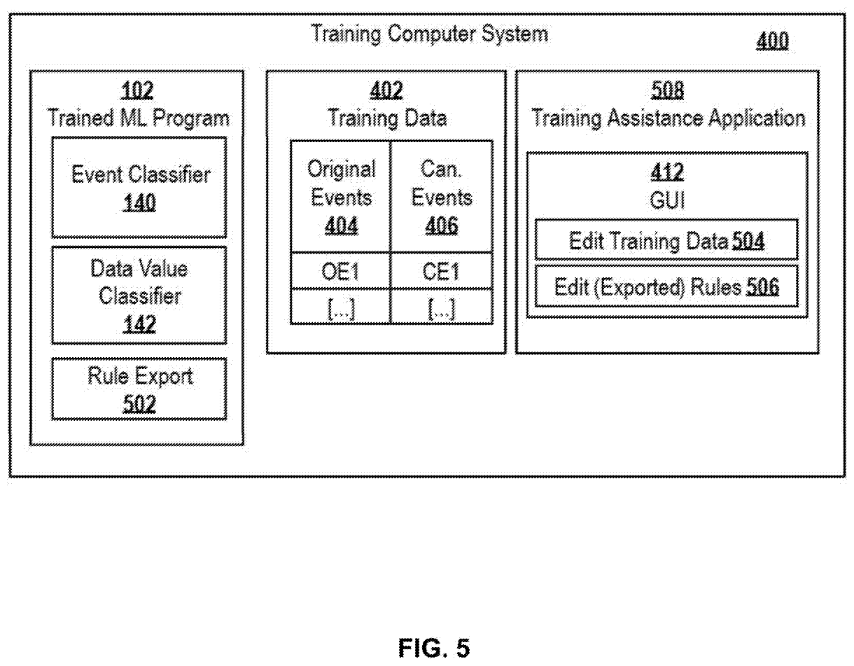

FIG. 5 depicts a training computer system comprising a software program 508 that can be used during and optionally also after training the ML program. The Program can comprise the GUI 412 enabling the user 414 to create, modify or supplement the training dataset 402.

According to some embodiments, the ML program 102 comprises a rule export function 502. Typically, the statistical model generated during the training of a ML program does not reveal the algorithm or heuristic how a particular output is computed. However, meanwhile there exist some approaches that allow exporting an explicit specification of the learned algorithm (see e.g. Hailesilassie, Tameru, 2016, “Rule Extraction Algorithm for Deep Neural Networks: A Review”). According to some embodiments, the GUI 412 in addition comprises functions and GUI elements 506 enabling the user to export explicit event object transformation rules from the trained ML program and/or for displaying and optionally also approving and/or modifying the displayed rules by a user 414. This may increase the security and accuracy of event object transformation as the user is provided with the option to review, confirm and/or modify an automatically learned object transformation scheme. According to other embodiments, the GUI enabling a user to export, display and/or modify the learned object transformation algorithm in the form of rules is not part of the training framework 508 but is rather provided by another software application running on another computer system, e.g. on the computer system used for transforming original event objects received from active IT-monitoring systems.

According to embodiments, the original event objects in the training data set respectively comprise a time indicating when the event occurred, wherein the training data set comprises multiple original event objects which represent the same type of event, having occurred in the same component of an IT system and having occurred at different times. During the training, the ML program learns to predict a trend as a function of a series of original events relating to the same IT component. The trained ML program is configured to predict, in response to receiving and processing a series of original event objects from the active IT monitoring system, a trend at least for the most current one of the original event objects of this series, and provide the predicted trend to the event handling system in combination with the canonical event object derived from the most current original event object.

A “series” means a chronological sequence of events, whereby the time intervals between two successive events may be constant or may vary.

According to some embodiments, the trained ML program is configured to predict a priority level of the canonical event object as a function of the predicted trend.

For example, the training dataset can comprise a series of four “storage full” original event objects for a particular hard disc drive DR2321. The first original event object may indicate an occupancy of 70% at May 23, 2019, 10:23. The second original event object may indicate an occupancy of 80% at Jun. 21, 2019, 09:23. The third original event object may indicate an occupancy of 90% at Jun. 21, 2019, 14:33. The fourth original event object may indicate an occupancy of 98% at Jun. 21, 2019, 14:45. The ML program has been trained to extrapolate a future occupancy based on a series of multiple original events of the type “storage full”. The change in storage occupancy from the first to the second event is quite moderate (10% in about one month) compared with the drastic change between the third and fourth event (8% in only 12 seconds). The trained ML program can be configured to create a first and second canonical event object from the respective first and second original event objects that has assigned a trend that indicates that the storage may be fully occupied in about two months. The priority level assigned to the first and second canonical event object, if any, may indicate a low priority level. However, trained ML program will create a third and a fourth canonical event object from the third and fourth original event objects, whereby the third and in particular the fourth canonical event objects will have assigned a predicted trend indicating that the storage may be fully occupied in a few hours or within the next second. The priority level assigned to the third and in particular the fourth canonical event object, if any, may indicate a high or a very high priority level that is adapted to trigger the event handler to immediately start a function that prevents the blocking of write transactions on this disc drive, e.g. by automatically deleting temporary files on this disc, by redirecting new write transaction to another disc drive, etc.

These features may be advantageous as the trained ML program may be able to automatically creating canonical event objects comprising predicted trends and/or trend-dependent priority levels which allow a downstream event handling system to immediately and accurately determine how urgent a particular technical problem needs to be addressed and at what time in the future a severe failure of an IT system or some of its components have to be expected. It should be noted that in complex IT systems the trends and urgencies may not always be as obvious as indicated in the above specified disk full event example. For example, in a complex IT system, many different components and operations may have an effect on the occupancy of a particular disk: the number and identity of users having write access permission to the disk; usage patterns that may depend on the user and on the time of the day; some backup routines which may use the disk for storing backups; one or more application programs or services which may use the disk for storing temporary files; some of these applications can be services offered to a plurality of users via the network, and the number of users served by a particular instance of a service may depend on load-balancing algorithms performed in a complex cloud IT infrastructure. Hence, the simple question when a particular disk drive will be fully occupied can praxis be highly complex and in fact unforeseeable for human user. Embodiments of the invention allow automatically creating an application program that is able not only to transform original event objects into canonical event objects that have the appropriate format for downstream processing, but which in addition comprise valuable information about trends of IT component attributes (storage occupancy, CPU occupancy, network traffic, number of sessions served by web application, number of concurrently open database connections, etc.) and information about the priority level of this event that is able to integrate and aggregated information of a plurality of highly interdependent, linearly or nonlinearly interacting IT system components. By providing the predicted trends and/or predicted priority level as an integral part of or in association with the canonical event object for which they were computed, the downstream event handling system is enabled to control and manage an IT system and any workflow performed by the IT system in a faster and more accurate manner. It should be noted that the complex prediction logic does not require any user to understand the multiple and complex interdependencies of components of an IT system. Rather, these interdependencies are implicitly learned during the training phase by the ML program from the training data set.

As a consequence, the trained ML program is able to generate canonical event data that enables any downstream event handling system to quickly and accurately decide which of the provided events has to be addressed first, what kind of countermeasures needs to be taken and what possible root causes may be responsible for a particular event. For example, the countermeasures may depend on whether the data that has consumed the whole storage space is mainly user data written by individual users or is backup data automatically generated by a backup system. The countermeasures may depend on whether the trend linear or on whether there is a nonlinear acceleration in storage consumption and/or on whether the trend correlates with other canonical events, e.g. events indicating a current number of user sessions of a particular service instance with a plurality of remote cloud service clients.

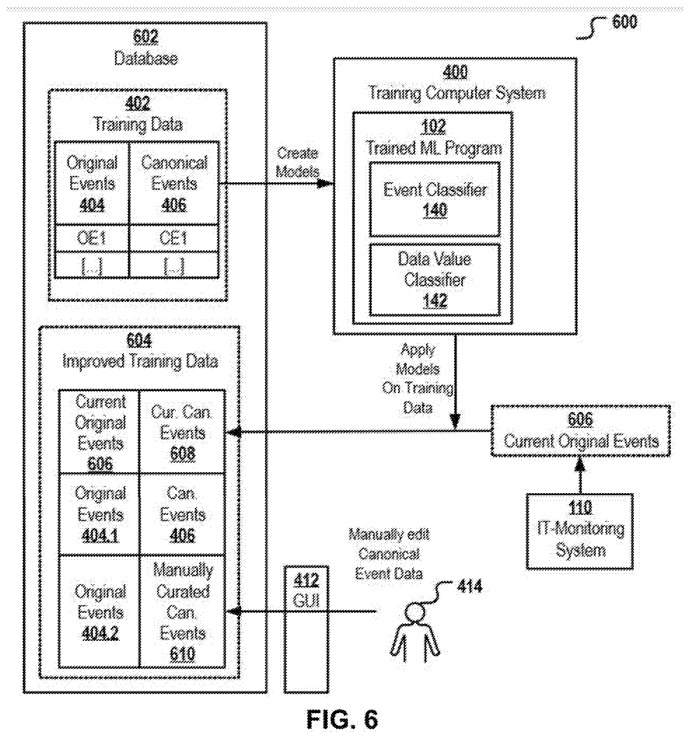

FIG. 6 depicts a method of supplementing and improving training data and a corresponding distributed computer system 600. The system 600 comprises a training computer system 400 that comprises a trained ML program 102 and that comprises or is operatively coupled to a database 602. The database comprises training data 402 that was used for training the trained ML program 102. The training data comprises original event objects 404 and respectively assigned canonical events 406.

In addition, the system 600 comprises one or more IT monitoring systems 110 that are active and that send current, “new” original event objects 606 via a network to the trained ML program. The “new” original event objects are original event objects that are created and provided after the ML program was trained on the training dataset 402. The ML program is configured to automatically transform any original event object 606 received from the active IT monitoring system into a new canonical event object 608 that is stored in association with the respective new original event object 606 from which it was derived in the database 602. Then, the trained ML program sends the created canonical event objects 608 to an event handling system (not shown). Optionally, the trained ML program may be configured to predict an event resolution workflow definition and assign the predicted definition to the canonical event object that is forwarded to the event handling system, thereby enabling the event handling system to handle the event in accordance with the workflow definition.

Hence, the database 602 comprises both historical event information that may be received from one or more independent IT-monitoring systems and/or organizations and in addition stores current original event objects and their “normalized”, canonical form.

According to embodiments, the training framework or other software application instantiated on the training computer system 400, so called “enrichment services”, periodically analyze the new original event objects and their associated canonical event objects and “suggests” the canonical event objects to be manually or automatically supplemented by missing attribute values. For example, the already trained ML program can be re-applied on the original training data 402 and on further canonical event data objects 610 that have been created manually or automatically for newly incoming original event objects. In other words, the already trained ML program can be re-applied on an improved, supplemented version 604 of the training data 402 that was previously used for training. Thereby, a re-trained version of the trained ML program is provided that is adapted to perform a more accurate, in particular more complete transformation of the information in the original event objects into the canonical event objects.

In addition, or alternatively, the trained and/or re-trained ML program is configured to export the implicitly learned event object transformation logic into one or more explicit, human-readable rules. These rules are presented to a user via a GUI enabling the user to modify and/or approve the rule. In case the user approves to the rules exported by a re-trained ML program, the re-trained ML program or the rules exported by the re-trained ML program will be used for processing all new original event objects to be received in the future.

For example, the retraining of an ML program and the supplementing of canonical event objects can be performed as follows:

The trained ML program 102 has learned, during the initial training, to identify important name value pairs (including identifying/flagging missing information) in an original event object such as:

| | |
|---|---|
| — | Disk Y exceeds 50% on system X. → Storagevolume=“Y” |
| | storageutilization=“>50%” system=“X” |
| — | Filesystem Y is full. → Storagevolume=“Y” storageutilization=“full” |
| | system=<missing> |
| — | Website response time more than 2ms → responsetime=“>2ms” |
| | system=“website” |

During the training, the ML program learns to predict the event class based on information contained in the original event objects. The trained ML program also learns to which attributes required in accordance with the canonical data format a data value extracted from an original event object corresponds:

| | |
|---|---|
| — | § “ITM6 the filesystem X is 80% full” → Storage Event, |
| | “filesystem X”=“80% full” |
| — | § “SCOM disk C: exceeds 20%” → Storage Event, |
| | “disk C:”=“exceeds 20%” |

According to embodiments, the trained ML program has learned to identify and resolve attribute name synonyms and to use NLP techniques to extract required attributes and attribute values from natural language text in the original event objects:

| | |
|---|---|
| — | § Storage Event, “filesystem X”=“80% full” → Storage |
| | Event(utilization=“=80%”) |
| — | § Storage Event, “disk C:”=“exceeds 20%” → Storage |
| | Event(utilization=“>20%”) |
| — | § Storage Event, “disk C:”=“exceeds 90GB” → Storage |
| | Event(used=“>90GB”) |

According to embodiments, the event handling system receiving a canonical event object from the trained or re-trained ML program can be configured to requests ticketing, notification and/or automation. For example, the event handling system can be a dynamic automation service or the event handling system can forward the canonical event object to a dynamic automation service that maps canonical event objects to available automata. The workflow chosen by the event handler for processing a canonical event object can also be stored in the database 602 as metadata of the respective canonical event object. This metadata can also be provided as input to the ML program during the re-training.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Possible combination of features described above can be the following: Feature combination 1 (FC1):
FC1: A computer-implemented method for processing events, the method comprising:
   providing a database comprising a plurality of original event objects respectively being stored in association with a canonical event object,
      the original event objects being generated by one or more IT-monitoring systems, each of the original event object having an original data format being particular for the type of IT monitoring system having generated the original event object, each original event object comprising one or more data values characterizing an event,
      the canonical event objects having a shared canonical data format, each canonical event object comprising a class-ID being indicative of the one out of a plurality of event classes to which its associated original event object has been manually and/or automatically assigned for handling the event represented by the original event object, the canonical event object comprising one or more attribute values derived from the data values of the associated original event object;
   executing a learning algorithm on the associated original and canonical event objects for generating a trained machine learning program adapted to transform an original event object of any one of the one or more original data formats into a canonical event object having the canonical data format; and
   using the trained machine learning program for automatically transforming original event objects generated by an active IT-monitoring system into canonical event objects respectively being processable by an event handling system, the active IT-monitoring system being one of the one or more IT-monitoring systems or of a further IT-monitoring system.
FC2: The method of FC1, the using of the trained machine learning program comprising:
   receiving a new original event object from one of the IT-monitoring systems;
   using the trained machine learning program for automatically transforming the new original event object into a new canonical event object having canonical data format; and
   providing the new canonical event object to the event handling system for automatically handling the new event represented by the new canonical event object as a function of the attribute values contained in the new canonical event object.
FC3: The computer-implemented method of any one of the previous feature combinations FC1-FC2, the canonical data format being interpretable by the event handling system, at least some of the original data formats not being interpretable by the event handling system.
FC4: The computer-implemented method of any one of the previous feature combinations FC1-FC3, the using of the trained machine learning program for automatically transforming the new original event object into a new canonical event object comprising performing the transformation directly by the trained machine-learning program.
FC5: The computer-implemented method of any one of the previous feature combinations FC1-FC4, the using of the trained machine learning program for automatically transforming the new original event object into a new canonical event object comprising:
   exporting, by the trained machine-learning program, one or more explicit event object transformation rules;
   inputting the explicit event object transformation rules into a rules engine;
   performing, by the rules engine, the transformation of the original event object into the canonical event object in accordance with the input event object transformation rules.
FC6: The computer-implemented method of feature combination FC5, further comprising:
   generating a GUI that enables a user to modify and/or confirm the one or more explicit event object transformation rules.
FC7: The computer-implemented method of any one of the previous feature combinations FC1-FC6, wherein the class ID and the attribute values of at least some of the canonical event objects in the database have been specified by a human user manually.
FC8: The computer-implemented method of any one of the previous feature combinations FC1-FC7, wherein the class ID and the attribute values of at least some of the canonical event objects in the database have been created automatically by the event handler.
FC9: The computer-implemented method of any one of the previous feature combinations FC1-FC8, further comprising:
   preprocessing the received original event object, the preprocessed original event object being transformed by the machine learning program into the new canonical event object, the preprocessing comprising:
      applying one or more natural language processing functions on the new original event object for extracting one or more data values contained in the new original event object; and/or
      applying a parser on the new original event object for extracting one or more data values contained in the new original event object; and/or
      checking if the extracted data values comprise one or more distinct event class names and, if so, assigning an event class label to the extracted data value; and/or
      checking if the extracted data values comprise one or more distinct attribute names and, if so, assigning a data field name to the extracted data value, the data field name being chosen in accordance with the canonical data format; and/or
      adding one or more data values extracted from the original event object by a parser and/or by a natural language processing function as attribute values and/or as event class name to the preprocessed original event object.
FC10: The computer-implemented method of any one of the previous feature combinations FC1-FC9, wherein the transformation of the received original event object into the new canonical event object comprises:
   automatically computing a priority level as a function of the data values of the new original event object and storing the priority level as an attribute value in the new canonical event object.
FC11: The computer-implemented method of feature combination FC10, further comprising:
   analyzing, by the event handling system, the priority level of the new canonical event object for automatically prioritizing the new event in accordance with its priority level.
FC12: The computer-implemented method of any one of the previous feature combinations FC1-FC11, the data values of the original event objects being selected from a group comprising:
   an identifier of a data processing system having triggered the generation of the original event; or
   an operating system of a computer system having triggered the generation of the original event object; or
   time and date of the moment when the generation of the original event was triggered; or
   a geographic location comprising the object having triggered the generation of the original event object; or
   a numerical value or value range being indicative of the severity, size or priority of a technical problem; or
   one or more string describing the event and or the data processing system or system component having triggered the generation of the original event; or
   a mount point, i.e., the location in a file system that a newly-mounted medium was registered during a mounting process of the medium, wherein the mounting process is a process by which the operating system makes files and directories on a storage device accessible via the computer's file system; this can be an important information e.g. for events which are mounting-related events, e.g. mounting-failed events or mounting-completed events; or
   an internal device ID, e.g. an internal device ID of a device having triggered the generation of the original event; or
   a combination of two or more of the aforementioned data values.
FC13: The computer-implemented method of any one of the previous feature combinations FC1-FC12, the event class of the new canonical event object being selected from a group comprising:
   a storage full event;
   a network connection failure event;
   a task queue full event;
   a server unavailable event;
   a mounting event;
   a timeout event of a request or command sent to a device;
FC14: The computer-implemented method of any one of the previous feature combinations FC1-FC13,
   one or more of the canonical event objects in the database having assigned an event-resolution workflow definition, the learning algorithm being executed on the associated original and canonical event objects and the assigned event-resolution workflow definitions, the trained machine learning program being adapted to transform an original event object of any one of the one or more original data formats into a canonical event object having the canonical data format and having assigned a predicted event-resolution workflow definition;
   the using of the trained machine learning program for automatically transforming original event objects into canonical event objects preferably further comprising automatically transforming any received new original event object into a new canonical event object having canonical data format, the canonical event object comprising an event-resolution workflow definition predicted by the trained ML program as a function of the received new original event object.
FC15: The computer-implemented method of any one of the previous feature combinations FC1-FC14, the machine learning program comprising:
   an event classifier adapted to identify one out of a predefined set of event classes an original event object belongs in dependence of the data values contained in the original event object and to use the identified event object to assign the class-ID to the canonical event object generated by transforming the original event object; and
   a data value classifier adapted to identify one out of a predefined set of attribute types a data value contained in a original event object belongs, the determination being performed in dependence of the position and combination of data values contained in the original event object, and to store the classified data values as attribute values at predefined positions in the canonical event object generated by the transformation of the original event object.
FC16: The computer-implemented method of any one of the previous feature combinations FC1-FC15, further comprising:
   analyzing the canonical event objects in the database for determining if some or all canonical event objects lack an attribute value required according to the canonical data format;
   in case the analysis reveals that at least one of the canonical event objects lacks an attribute value required according to the canonical data format, applying the trained ML program on the original event objects in the database to create updated versions of the canonical event objects that comprise the attribute value that was determined to be lacking; and
   retraining the trained ML program on the original event objects and the respectively assigned updated versions of the canonical data objects in the database for providing a re-trained version of the machine-learning program.
FC17: A computer system comprising:
   a database comprising a plurality of original event objects respectively being stored in association with a canonical event object,
      the original event objects being generated by one or more IT-monitoring systems, each of the original event object having an original data format being particular for the type of IT monitoring system having generated the original event object, each original event object comprising one or more data values characterizing an event,
      the canonical event objects having a shared canonical data format, each canonical event object comprising a class-ID being indicative of the one out of a plurality of event classes to which its associated original event object has been manually and/or automatically assigned for handling the event represented by the original event object, the canonical event object comprising one or more attribute values derived from the data values of the associated original event object;
   a machine-learning framework configured to apply a learning algorithm on the associated original and canonical event objects for generating a trained machine learning program adapted to transform an original event object of any one of the one or more original data formats into a canonical event object having the canonical data format.
FC18: A computer system comprising:
   a trained machine learning program configured to transform original event objects having one or more original data format into a canonical event object having canonical data format, each of the original event objects comprising one or more data values characterizing an event, the canonical data format being processable by a local or remote event handling system, each of the original data format of each of the original event objects being particular for the type of IT monitoring system having generated the original event object;
   an interface for receiving a new original event object from one or more active IT-monitoring systems, each of the active IT-monitoring systems;
   an interface to the local or remote event handling system;
   a transformation coordination program adapted to
      use the trained machine learning program for automatically transforming the received new original event object into a new canonical event object having canonical data format, the canonical event object comprising one or more attribute values derived from the data values of the associated original event object; and
      providing the new canonical event object to the event handling system for automatically handling the new event represented by the new canonical event object as a function of the attribute values contained in the new canonical event object.
FC19: The computer system of feature combination 18, further comprising the event handling system.
FC20: A system being or comprising the computer system of FC17 and being or comprising the event-handling computer system of FC18 or FC19.

1. A computer-implemented method for processing events, the method comprising:
providing a database comprising a plurality of original event objects respectively being stored in association with a canonical event object, wherein the original event objects being generated by one or more IT-monitoring systems, wherein each of the original event object having an original data format being particular for the type of IT monitoring system having generated the original event object, wherein each original event object comprising one or more data values characterizing an event, wherein the canonical event objects having a shared canonical data format, wherein each canonical event object comprising a class-ID being indicative of the one out of a plurality of event classes to which its associated original event object has been assigned for handling the event represented by the original event object, the canonical event object comprising one or more attribute values derived from the data values of the associated original event object;
executing a learning algorithm on the associated original and canonical event objects for generating a trained machine learning program adapted to transform an original event object of any one of the one or more original data formats into a canonical event object having the canonical data format; and
using the trained machine learning program for automatically transforming original event objects generated by an active IT-monitoring system into canonical event objects respectively being processable by an event handling system.

2. The method of claim 1, wherein the using of the trained machine learning program comprising:
receiving a new original event object from one of the IT-monitoring systems;
using the trained machine learning program for automatically transforming the new original event object into a new canonical event object having canonical data format; and
providing the new canonical event object to the event handling system for automatically handling the new event represented by the new canonical event object as a function of the attribute values contained in the new canonical event object.

3. The computer-implemented method of claim 1, wherein the canonical data format being interpretable by the event handling system, wherein at least some of the original data formats not being interpretable by the event handling system.

4. The computer-implemented method of claim 1, wherein the using of the trained machine learning program for automatically transforming the new original event object into a new canonical event object comprising performing the transformation directly by the trained machine-learning program.

5. The computer-implemented method of claim 1, wherein the using of the trained machine learning program for automatically transforming the new original event object into a new canonical event object comprising:
exporting, by the trained machine-learning program, one or more explicit event object transformation rules;
inputting the explicit event object transformation rules into a rules engine; and
performing, by the rules engine, the transformation of the original event object into the canonical event object in accordance with the input event object transformation rules.

6. The computer-implemented method of claim 5, further comprising:
generating a GUI that enables a user to modify and/or confirm the one or more explicit event object transformation rules.

7. The computer-implemented method of claim 1, wherein the class ID and the attribute values of at least some of the canonical event objects in the database have been specified by a human user manually.

8. The computer-implemented method of claim 1, wherein the class ID and the attribute values of at least some of the canonical event objects in the database have been created automatically by the event handler.

9. The computer-implemented method of claim 1, further comprising:
preprocessing the received original event object, the preprocessed original event object being transformed by the machine learning program into the new canonical event object, the preprocessing comprising:
applying one or more natural language processing functions on the new original event object for extracting one or more data values contained in the new original event object;
applying a parser on the new original event object for extracting one or more data values contained in the new original event object;
checking if the extracted data values comprise one or more distinct event class names and, if so, assigning an event class label to the extracted data value;
checking if the extracted data values comprise one or more distinct attribute names and, if so, assigning a data field name to the extracted data value, the data field name being chosen in accordance with the canonical data format; and
adding one or more data values extracted from the original event object by a natural language processing function as attribute values or as event class names to the preprocessed original event object.

10. The computer-implemented method of claim 1, wherein the transformation of the received original event object into the new canonical event object comprises:
automatically computing a priority level as a function of the data values of the new original event object and storing the priority level as an attribute value in the new canonical event object.

11. The computer-implemented method of claim 10, further comprising:
analyzing, by the event handling system, the priority level of the new canonical event object for automatically prioritizing the new event in accordance with its priority level.

12. The computer-implemented method of claim 1, wherein the data values of the original event objects being selected from a group comprising:
an identifier of a data processing system having triggered the generation of the original event;
an operating system of a computer system having triggered the generation of the original event object;
a time and date of the moment when the generation of the original event was triggered;
a geographic location comprising the object having triggered the generation of the original event object;
a numerical value or value range being indicative of the severity, size or priority of a technical problem;
one or more strings describing the event and or the data processing system or system component having triggered the generation of the original event;
a mount point, wherein the mount point is the location in a file system that a newly-mounted medium was registered during a mounting process of the medium, wherein the mounting process is a process by which the operating system makes files and directories on a storage device accessible via the computer's file system; and
an internal device ID, wherein the internal device ID determined based on a device having triggered the generation of the original event.

13. The computer-implemented method of claim 1, wherein the event class of the new canonical event object being selected from a group comprising:
a storage full event;
a network connection failure event;
a task queue full event;
a server unavailable event;
a mounting event; and
a timeout event of a request or command sent to a device.

14. The computer-implemented method of claim 1, wherein one or more of the canonical event objects in the database having assigned an event-resolution workflow definition, wherein the learning algorithm being executed on the associated original and canonical event objects and the assigned event-resolution workflow definitions, the trained machine learning program being adapted to transform an original event object of any one of the one or more original data formats into a canonical event object having the canonical data format and having assigned a predicted event-resolution workflow definition, and wherein the using of the trained machine learning program for automatically transforming original event objects into canonical event objects preferably further comprising automatically transforming any received new original event object into a new canonical event object having canonical data format, the canonical event object comprising an event-resolution workflow definition predicted by the trained ML program as a function of the received new original event object.

15. The computer-implemented method of claim 1, wherein the machine learning program comprising:
an event classifier adapted to identify one out of a predefined set of event classes an original event object belongs in dependence of the data values contained in the original event object and to use the identified event object to assign the class-ID to the canonical event object generated by transforming the original event object; and
a data value classifier adapted to identify one out of a predefined set of attribute types a data value contained in a original event object belongs, the determination being performed in dependence of the position and combination of data values contained in the original event object, and to store the classified data values as attribute values at predefined positions in the canonical event object generated by the transformation of the original event object.

16. The computer-implemented method of claim 1, further comprising:
analyzing the canonical event objects in the database for determining if some or all canonical event objects lack an attribute value required according to the canonical data format;
based on determining that at least one of the canonical event objects lacks an attribute value required according to the canonical data format, applying the trained ML program on the original event objects in the database to create updated versions of the canonical event objects that comprise the attribute value that was determined to be lacking; and
retraining the trained ML program on the original event objects and the respectively assigned updated versions of the canonical data objects in the database for providing a re-trained version of the machine-learning program.

17. A computer system comprising:
a database comprising a plurality of original event objects respectively being stored in association with a canonical event object, wherein
the original event objects being generated by one or more IT-monitoring systems, each of the original event object having an original data format being particular for the type of IT monitoring system having generated the original event object, each original event object comprising one or more data values characterizing an event, wherein
the canonical event objects having a shared canonical data format, each canonical event object comprising a class-ID being indicative of the one out of a plurality of event classes to which its associated original event object has been manually and/or automatically assigned for handling the event represented by the original event object, the canonical event object comprising one or more attribute values derived from the data values of the associated original event object;
a machine-learning framework configured to apply a learning algorithm on the associated original and canonical event objects for generating a trained machine learning program adapted to transform an original event object of any one of the one or more original data formats into a canonical event object having the canonical data format.

18. A computer system comprising:
a trained machine learning program configured to transform original event objects having one or more original data format into a canonical event object having canonical data format, each of the original event objects comprising one or more data values characterizing an event, the canonical data format being processable by a local or remote event handling system, each of the original data format of each of the original event objects being particular for the type of IT monitoring system having generated the original event object;
an interface for receiving a new original event object from one or more active IT-monitoring systems, each of the active IT-monitoring systems;
an interface to the local or remote event handling system; and
a transformation coordination program adapted to:
using the trained machine learning program for automatically transforming the received new original event object into a new canonical event object having canonical data format, the canonical event object comprising one or more attribute values derived from the data values of the associated original event object; and
providing the new canonical event object to the event handling system for automatically handling the new event represented by the new canonical event object as a function of the attribute values contained in the new canonical event object.

19. The computer system of claim 18, further comprising the event handling system.

20. A computer program product for processing events, the computer program product comprising:
one or more computer-readable tangible storage medium and program instructions stored on at least one of the one or more tangible storage medium, the program instructions executable by a processor, the program instructions comprising:
program instructions to provide a database comprising a plurality of original event objects respectively being stored in association with a canonical event object, wherein the original event objects being generated by one or more IT-monitoring systems, wherein each of the original event object having an original data format being particular for the type of IT monitoring system having generated the original event object, wherein each original event object comprising one or more data values characterizing an event, wherein the canonical event objects having a shared canonical data format, wherein each canonical event object comprising a class-ID being indicative of the one out of a plurality of event classes to which its associated original event object has been assigned for handling the event represented by the original event object, the canonical event object comprising one or more attribute values derived from the data values of the associated original event object;
program instructions to execute a learning algorithm on the associated original and canonical event objects for generating a trained machine learning program adapted to transform an original event object of any one of the one or more original data formats into a canonical event object having the canonical data format; and
program instructions to use the trained machine learning program for automatically transforming original event objects generated by an active IT-monitoring system into canonical event objects respectively being processable by an event handling system.
